(19) United States
(12) Patent Application Publication
(10) Pub. No.: US 2021/0031999 A1
(43) Pub. Date: Feb. 4, 2021

(54) RESIN-COATED METAL SHEET FOR CONTAINER, CONTAINER FORMED OF RESIN-COATED METAL SHEET, AND METHOD FOR MANUFACTURING RESIN-COATED METAL SHEET

(71) Applicant: TOYO KOHAN CO., LTD., Tokyo (JP)

(72) Inventors: Kousuke SASAKI, Kudamatsu-shi, Yamaguchi (JP); Masami SUENAGA, Kudamatsu-shi, Yamaguchi (JP)

(21) Appl. No.: 16/975,514

(22) PCT Filed: Dec. 27, 2018
(86) PCT No.: PCT/JP2018/048217

§ 371 Date: Aug. 25, 2020

(30) Foreign Application Priority Data
Mar. 1, 2018 (JP) 2018-036380

(51) Int. Cl. B65D 65/40; B32B 15/09; B32B 15/20

(52) U.S. Cl. CPC B65D 65/40; B32B 15/09; B32B 15/20; B32B 2250/03; B32B 2439/70; B32B 2250/02; B32B 2307/732

(57) ABSTRACT

A resin-coated metal sheet according to the invention of the present application that can suppress occurrence of retort blushing (white spots) includes a metal sheet, and a resin layer A coated on at least one side of the metal sheet. The resin layer A contains a polyester resin as a principal component, and the polyester resin is a blend of 30 to 50 wt % of a polyester I having a melting point of 210° C. to 256° C. and 50 to 70 wt % of a polyester II having a melting point of 215° C. to 225° C. The resin layer A has, in X-ray diffraction thereof, a peak intensity ratio satisfying the following formulas (1) and (2): (I₁₀₀)_{II}/(I₁₀₀)_{I}≥1.5 ⋅ ⋅ ⋅ (1) and (I₁₀₀)_{II}/(I₀₁₁)_{II}≤1.5 ⋅ ⋅ ⋅ (2). The (I₁₀₀)_{II} is a maximum peak intensity observed in a range of 2θ=22.5° to 24.0° in X-ray diffraction of the polyester II, the (I₁₀₀)_{I} is a maximum peak intensity observed in a range of 2θ=25.4° to 26.7° in X-ray diffraction of the polyester I, and the (I₀₁₁)_{II} is a maximum peak intensity observed in a range of 2θ=16.0° to 18.0° in X-ray diffraction of the polyester II.

### TECHNICAL FIELD

The present invention relates to a resin-coated metal sheet for a container, the container formed from the resin-coated metal sheet, and a method of manufacturing the resin-coated metal sheet.

### BACKGROUND ART

As materials for containers such as metal cans for beverages or foods, resin-coated metal sheets with a thermoplastic resin film laminated on a surface of a metal sheet are conventionally known. As the thermoplastic resin film, a polyester film or the like is used.

Containers such as metal cans for beverages and foods described above need to withstand retort sterilization treatment to be applied after filling contents. For retort sterilization treatment, there is a plurality of methods such as batchwise and continuous methods. Batchwise retort treatment, for example, includes a step in which containers such as metal cans are exposed to high-temperature steam for several minutes to several tens of minutes. Continuous retort treatment, on the other hand, includes a step in which containers such as metal cans that have been carried into a sterilization chamber by an endless chain conveyor are exposed to high-temperature steam for several minutes to several tens of minutes.

Whichever the treatment is applied, the environment is severe for the metal sheet and the thermoplastic resin film laminated on the surface of the metal sheet. There is accordingly an outstanding demand for a thermoplastic resin film for lamination on a metal sheet such that no delamination or the like of the film from the metal sheet occurs even when the film is treated in such a severe environment.

Investigations have also been made to deal with the problem of retort blushing (white spots) that, with respect to the outer surface side of a container such as a metal can, may occur on the top and bottom lids of a 3-piece can or on the can bottom of a 2-piece can upon such retort sterilization treatment as described above. The term “retort blushing (white spots)” means a phenomenon that a resin layer becomes locally white to result in an impaired external appearance.

The cause of occurrence of such retort blushing (white spots) has not been completely ascertained yet.

As a reason, however, retort blushing (white spots) is presumably attributed to deposition of water droplets on a can lid or can bottom upon retort sterilization and crystallization of a film which has melted into an amorphous state during lamination at spots where the water droplets are deposited.

As an alternative, retort blushing (white spots) is also presumably attributed to transmission of water droplets which have deposited on a can lid or can bottom through a thermoplastic resin film and formation of bubbles between a metal sheet and the resin film.

As measures for resolving or alleviating the problem of such retort blushing (white spots), it has been proposed to use, as a thermoplastic resin film, a resin obtained by blending polyethylene terephthalate (PET) and polybutylene terephthalate (PBT). Polybutylene terephthalate has a high crystallization rate, and therefore can suppress the occurrence of retort blushing (white spots).

For example, PTL 1 discloses, as an organic resin-coated metal sheet for beverages and foods, the organic resin-coated metal sheet having retort blushing resistance and can-manufacturability, an organic resin-coated metal sheet with an unstretched film laminated on at least one side of a metal sheet. The unstretched film is characterized by being composed of a polyester based resin composition in which a crystalline polyester (II) with a polybutylene terephthalate based resin contained as a principal component therein is blended in a blend amount of from 20 to 45 wt % with a copolymer polyester (I) with a polyethylene terephthalate based resin contained as a principal component therein. On the other hand, its manufacturing method is characterized in that heat treatment is performed under predetermined conditions in any step after lamination of the unstretched film on the metal sheet and before performance of retort sterilization treatment.

PTL 2 discloses a laminated metal sheet for a container which is useful in suppressing whitening after retort sterilization treatment. Its film is configured of at least two layers which are each formed from a polyester as a principal component. A lower polyester resin layer, which is in contact with a metal sheet, contains 30 to 50 mol % of a PET component and 50 to 70 mol % of a PBT component. On the other hand, an upper polyester resin layer is formed from a polyester containing 90 mol % or more of the PBT component.

PTL 3 discloses PET/PBT blend films as films to be used on the outer surface sides of containers. Especially in the examples, there are disclosed films of a two-layer structure in which the lower layers contain 5 to 80 mol % of PBT and the surface layers contain 80 mol % or more of PET. As described hereinbefore, it is an object of the inventions of the above-described patent literature to reduce the local crystallization and the occurrence of patchy opaque spots in polyester films during retort treatment after filling cans with contents.

### CITATION LIST

### Patent Literature

### [PTL 1]

WO 2015/012222

### [PTL 2]

Japanese Patent No. 6011753

### [PTL 3]

Japanese Patent No. 3924239

### SUMMARY

### Technical Problems

The cause of occurrence of retort blushing (white spots) has a significant relation to the crystalline state of a resin layer. Moreover, the crystalline state of the resin layer changes under heat to which the resin layer is exposed in the manufacturing process of a container such as a metal can. To suppress the occurrence of retort blushing (white spots), there is hence a need to control, in view of how many times and how much the resin layer is to be exposed to the heat in the manufacturing process of the container, the crystalline state of the resin layer at the stage of a resin-coated metal sheet before the manufacture of the container.

As metal cans such as drawn cans and drawn and ironing (DI) cans, for example, there are cans with prints on their outer surfaces and cans without such prints. A can with no prints thereon is shipped by wrapping a sheet of printed paper on the side of its outer surface after its manufacture.

In the case of a can with no prints on its outer surface as described above, the manufacturing process of the can includes neither a printing step nor a baking step after printing. In terms of a thermal history that a resin layer undergoes, the can with no prints on its outer surface is therefore considered to be subjected to a correspondingly less thermal history than a can with prints on its outer surface.

If a resin layer is exposed to heat equal to or lower than the melting point of its resin, crystallization of the resin generally proceeds. In the case of the can with no prints on its outer surface, its resin layer is thus considered to have undergone correspondingly less crystallization. With these phenomena in view, it is an object of the present embodiment to suppress, even if a metal can has no prints on its outer surface, eventual occurrence of retort blushing (white spots) on the metal can after the can-making work and retort sterilization treatment by controlling the crystalline state of a resin layer at the stage of a resin-coated metal sheet.

As mentioned above, it is already known that an increase in the amount of PBT in a PET/PBT blend resin as a solution for the achievement of the above-described object leads to a higher crystallization rate and hence is effective for the suppression of retort blushing (white spots).

Nonetheless, with the amounts of PBT in the resins described in PTL 1, for example, it is difficult to fully suppress the occurrence of retort blushing (white spots) to such an extent as in the case of including no printing step upon can making (being not subjected to heat treatment under the predetermined conditions described in the literature). It is therefore considered that, even in the case of including no printing step upon can making, the occurrence of retort brushing (white spots) can be suppressed by further increasing the amount of PBT beyond those in the technique described in PTL 1.

On the other hand, if the amount of PBT is increased, the melting point of the resin is depressed correspondingly. Accordingly, the melted resin sticks to rolls during lamination. For this or like reason, a problem of deteriorated lamination properties arises newly. It is an object of the technique disclosed, for example, in PTL 2 to suppress the occurrence of a whitening phenomenon (retort whitening) by increasing the amount of PBT. In the case of the technique disclosed in PTL 2, however, there is a problem that, when laminating a resin film onto a metal sheet, because of a melting point depression of the resin, temperature irregularity of the film, and so on, the melted resin sticks to rolls and the lamination properties are deteriorated.

The technique of PTL 3 attempts to resolve the problem of the above-described deteriorations in lamination properties by forming a resin layer in a two-layer configuration, having the PET component contained more in a surface layer that is to come into contact with rolls upon lamination, and having the PBT component contained more in a lower layer that is close to a metal sheet. With the technique of PTL 3, however, the occurrence of retort blushing (white spots) cannot be suppressed sufficiently. As a reason for this, it is presumed that uniform crystallization of the resin in the lower layer is hampered by the existence of the surface layer abundant in the PET component or that transmission of water into the resin layer cannot be fully suppressed.

In view of various problems such as those described above, the present inventors studied to find a measure for resolving the problem of such retort blushing (white spots) as described above even if no printing step is included upon can making.

The present inventors also made research regarding the manufacture of a resin-coated metal sheet, which resolves the problem of such retort blushing (white spots) as describe above and at the same time, is excellent in the adhesion between the film and the metal sheet, workability enabling the metal sheet to withstand severe working such as drawing and ironing upon can making, and the like.

As a result, the present inventors have found that the above-described problem can be overcome by adopting a specific composition for a PET/PBT blend resin, leading to the present invention.

### Solution to Problems

Described specifically, the present invention has the following characteristic features.

(1) A resin-coated metal sheet of the present invention for a container includes a metal sheet, and a resin layer A coated on at least one side of the metal sheet. The resin layer A contains a polyester resin as a principal component, and the polyester resin is a blend of 30 to 50 wt % of a polyester I having a melting point of 210° C. to 256° C. and 50 to 70 wt % of a polyester II having a melting point of 215° C. to 225° C. The resin layer A has, in X-ray diffraction thereof, a peak intensity ratio satisfying the following formulas (1) and (2):

(I₁₀₀)_{II}/(I₁₀₀)_{I}≥1.5 (1)

(I₁₀₀)_{II}/(I₀₁₁)_{II}<1.5 (2)

where the (I₁₀₀)_{II} is a maximum peak intensity observed in a range of 2θ=22.5° to 24.0° in X-ray diffraction of the polyester II,

the (I₁₀₀)_{I} is a maximum peak intensity observed in a range of 2θ=25.4° to 26.7° in X-ray diffraction of the polyester I, and

the (I₀₁₁)_{II} is a maximum peak intensity observed in a range of 2θ=16.0° to 18.0° in X-ray diffraction of the polyester II.

(2) Further, another resin-coated metal sheet of the present invention for a container includes a metal sheet, and a resin layer B coated on at least one side of the metal sheet. The resin layer B includes two or more layers and has a resin layer A as an outermost layer, and the resin layer B includes at least a main layer between the resin layer A and the metal sheet. The resin layer A is formed from a blend of 30 to 50 wt % of a polyester I having a melting point of 210° C. to 256° C. and 50 to 70 wt % of a polyester II having a melting point of 215° C. to 225° C. The main layer is formed from a blend of 20 to 50 wt % of the polyester I having the melting point of 210° C. to 256° C. and 50 to 80 wt % of the polyester II having the melting point of 215° C. to 225° C. The resin layer B has, in X-ray diffraction thereof, a peak intensity ratio satisfying the following formulas (1) and (2):

(I₁₀₀)_{II}/(I₁₀₀)_{I}≥1.5 (1)

(I₁₀₀)_{II}/(I₀₁₁)_{II}<1.5 (2)

where the (I₁₀₀)_{II} is a maximum peak intensity observed in a range of 2θ=22.5° to 24.0° in X-ray diffraction of the polyester II,

the (I₁₀₀)_{I} is a maximum peak intensity observed in a range of 2θ=25.4° to 26.7° in X-ray diffraction of the polyester I, and

the (I₀₁₁)_{II} is a maximum peak intensity observed in a range of 2θ=16.0° to 18.0° in X-ray diffraction of the polyester II.

(3) In the resin-coated metal sheet of the present invention for a container as described above in item (1) described above, the resin layer A may preferably have a thickness in a range of 3 to 25 μm.

(4) In the resin-coated metal sheet of the present invention for a container as described above in item (2), the resin layer B may preferably have a thickness in a range of 3 to 25 μm.

(5) A container of the present invention is made from the resin-coated metal sheet for a container described in any one of items (1) to (4).

(6) A method of the present invention of manufacturing a resin-coated metal sheet for a container includes a first step of extruding a polyester resin in a melted state from a die head of an extruder directly onto a metal sheet, the polyester resin being a blend of 30 to 50 wt % of a polyester I having a melting point of 210° C. to 256° C. and 50 to 70 wt % of a polyester II having a melting point of 215° C. to 225° C., and a second step of bonding the polyester resin which has been extruded directly onto the metal sheet under pressure between laminating rolls to form a resin layer A. The resin layer A has, in X-ray diffraction thereof, a peak intensity ratio satisfying the following formulas (1) and (2):

(I₁₀₀)_{II}/(I₁₀₀)_{I}≥1.5 (1)

(I₁₀₀)_{II}/(I₀₁₁)_{II}<1.5 (2)

where the (I₁₀₀)_{II} is a maximum peak intensity observed in a range of 2θ=22.5° to 24.0° in X-ray diffraction of the polyester II,

the (I₁₀₀)_{I} is a maximum peak intensity observed in a range of 2θ=25.4° to 26.7° in X-ray diffraction of the polyester I, and

the (I₀₁₁)_{II} is a maximum peak intensity observed in a range of 2θ=16.0° to 18.0° in X-ray diffraction of the polyester II.

(7) In addition, a method of the resent invention of manufacturing a resin-coated metal sheet for a container includes a first step of concurrently extruding a polyester resin which is a blend of 30 to 50 wt % of a polyester I having a melting point of 210° C. to 256° C. and 50 to 70 wt % of a polyester II having a melting point of 215° C. to 225° C. and a polyester resin for a main layer in melted states from a die head of an extruder directly onto a metal sheet such that a plurality of layers are formed, and a second step of bonding the polyester resins which have been extruded directly onto the metal sheet under pressure between laminating rolls to form a resin layer B that includes two or more layers. The polyester resin for the main layer is a polyester resin obtained by blending 20 to 50 wt % of the polyester I having the melting point of 210° C. to 256° C. and 50 to 80 wt % of the polyester II having the melting point of 215° C. to 225° C. The resin layer B has, in X-ray diffraction thereof, a peak intensity ratio satisfying the following formulas (1) and (2):

(I₁₀₀)_{II}/(I₁₀₀)_{I}≥1.5 (1)

(I₁₀₀)_{II}/(I₀₁₁)_{II}<1.5 (2)

where the (I₁₀₀)_{II} is a maximum peak intensity observed in a range of 2θ=22.5° to 24.0° in X-ray diffraction of the polyester II,

the (I₁₀₀)_{I} is a maximum peak intensity observed in a range of 2θ=25.4° to 26.7° in X-ray diffraction of the polyester I, and

the (I₀₁₁)_{II} is a maximum peak intensity observed in a range of 2θ=16.0° to 18.0° in X-ray diffraction of the polyester II.

### Advantageous Effects of Invention

According to the present invention, it is possible to provide a resin-coated metal sheet which resolves the problem of retort blushing (white spots) during retort sterilization treatment and at the same time, is excellent in the adhesion between a film and a metal sheet, workability enabling the metal sheet to withstand severe working such as drawing and ironing upon can making, and the like.

According to the present invention, it is also possible to provide a can made from the resin-coated metal sheet and a method of manufacturing the resin-coated metal sheet.

### BRIEF DESCRIPTION OF DRAWINGS

FIG. 1 is a concept diagram illustrating one example of a resin-coated metal sheet according to the present invention.

FIG. 2 is a concept diagram illustrating an alternative example of the resin-coated metal sheet according to the present invention.

### DESCRIPTION OF EMBODIMENT

The present invention will hereinafter be descried in detail based on the following embodiment. It is, however, to be noted that the present invention should not be limited to or by the following embodiment.

### [Resin-Coated Metal Sheet for Container]

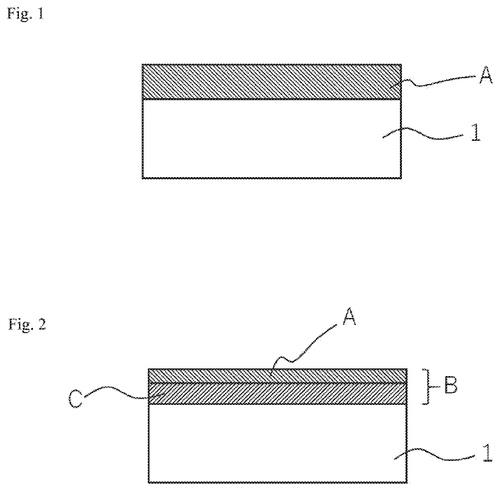

As illustrated in FIG. 1, a resin-coated metal sheet for a container in the present embodiment includes a metal sheet 1 and a resin layer A disposed on at least one side of the metal sheet.

It is to be noted that the resin layer A may preferably be disposed on a side which becomes an outer surface of a container when the metal sheet is formed into the container.

### <Metal Sheet>

As the metal sheet 1, a known metal sheet used in general containers such as metal cans can be used, and no particular limitation is imposed thereon. As an example of a preferably usable metal sheet, a surface-treated steel sheet or a light metal sheet such as an aluminum sheet or an aluminum alloy sheet can be used.

As the surface-treated steel sheet, aluminum killed steel, low-carbon steel, or the like can be used. For example, a cold-rolled steel sheet can be used after subjecting it to annealing and then to secondary cold rolling, and further applying one or more of tin plating, nickel plating, zinc plating, electrolytic chromate treatment, chromate treatment, non-chromate treatment using aluminum or zirconium, and the like.

As the light metal sheet, the aluminum sheet or the aluminum alloy sheet is used. As examples of the aluminum alloy sheet, A3000 series (Al—Mn system) can be used for metal can bodies. For can lids, on the other hand, A5000 series (Al—Mg system) can be used, for example.

It is to be noted that the thickness and the like of such a metal sheet can be selectively determined as desired depending on the purpose of use.

### <Resin Layer>

In the present embodiment, the resin layer A is disposed on at least one side of the metal sheet 1. The resin layer A is characterized in that a polyester resin is contained as a principal component and the polyester resin is a blend (hereinafter also called “mix”) of 30 to 50 wt % of a polyester I having a melting point of 210° C. to 256° C. and 50 to 70 wt % of a polyester II having a melting point of 215° C. to 225° C.

In the present embodiment, the polyester I is a polyethylene terephthalate based resin. Here, the term “polyethylene terephthalate based resin” shall encompass a polyethylene terephthalate (PET) resin alone and copolymer resins containing polyethylene terephthalate as a principal component.

On the other hand, the polyester II is a polybutylene terephthalate based resin. Here, the term “polybutylene terephthalate based resin” embraces a polybutylene terephthalate (PBT) resin alone and copolymer resins containing polybutylene terephthalate as a principal component.

In the present embodiment, the amounts of the polyester I and polyester II in the resin layer A are 30 to 50 wt % and 50 to 70 wt %, respectively, for a reason to be described hereinafter.

In general, polybutylene terephthalate (PBT) resin is known as a resin having high stiffness and a high crystallization rate.

In the present embodiment, if the amount of the polyester II (polybutylene terephthalate based resin) in the resin layer A is 50 to 70 wt %, the crystallization rate of the whole resin layer A is preferred and the size of crystals in the resin layer A becomes small, resulting in a lower possibility of occurrence of retort blushing (white spots). Such an amount of the polyester II (polybutylene terephthalate based resin) is therefore preferred.

If the amount of the polyester II (polybutylene terephthalate based resin) in the resin layer A is higher than 70 wt %, on the other hand, the melting point of the whole resin layer A decreases excessively. Such an excessively decreased melting point leads to a higher possibility of causing a reduction in lamination properties such as sticking of the resin to laminating rolls when forming the resin layer on the metal sheet 1, and therefore is not preferred.

If the amount of the polyester II (polybutylene terephthalate based resin) is lower than 50 wt % in the resin layer A, on the other hand, the crystallization rate of the whole resin layer A also decreases. As a result, crystals excessively grow in size in the resin layer A, leading to a higher possibility of clouding of the resin layer A or occurrence of retort blushing (white spots) in the resin layer A. Such a small amount of the polyester II (polybutylene terephthalate based resin) is therefore not preferred.

In the present embodiment, it is an object to resolve the problem of retort blushing (white spots) while ensuring good lamination properties at the time of formation of the resin layer A even if no printing step is included upon can making. To achieve this object, 30 to 50 wt % of the polyester I and 50 to 70 wt % of the polyester II are blended, as polyester resins constituting the resin layer A, in view of such properties of the PBT resin as described above.

The polyester I may preferably have a melting point of 210° C. to 256° C., while the polyester II may preferably have a melting point of 215° C. to 225° C. These melting points can be measured using, for example, differential scanning calorimetry (DSC). As an alternative, they may also be measured using a method that is commonly employed to determine the melting points of resins.

Described specifically, the polyester I may preferably be a copolymer resin containing polyethylene terephthalate as a principal component in the present embodiment. Here, the melting point of the polyester I can be appropriately adjusted by selecting the type of the copolymerization component.

If a copolymer resin with polyethylene terephthalate contained as a principal component is used as the polyester I, for example, terephthalic acid is primarily contained as a dicarboxylic acid component in the copolymer resin. As an additional copolymerization component, it is preferred to contain at least one dicarboxylic acid selected from the group consisting of isophthalic acid (IA), orthophthalic acid, p-R-oxyethoxybenzoic acid, naphthalene-2,6-dicarboxylic acid, diphenoxyethane-4,4′-dicarboxylic acid, monosodium 5-sulfoisophthalate, hexahydroterephthalic acid, adipic acid, sebacic acid, trimellitic acid, and pyromellitic acid.

Of these, isophthalic acid is particularly preferred as a copolymerization component from the viewpoint of workability or the like into containers such as metal cans.

It is to be note that, if a copolymer resin with polyethylene terephthalate contained as a principal component is used as the polyester I in the present embodiment, the amount of isophthalic acid in the copolymer resin may preferably be 2 to 15 mol % for a reason to be described hereinafter. If the amount of isophthalic acid in the polyester I is lower than 2 mol %, the adhesion of the resin layer to the metal sheet is lowered. Such a small amount of isophthalic acid is not preferred accordingly.

If the amount of isophthalic acid in the polyester I is higher than 15 mol %, on the other hand, the crystallization rate of the resin layer decreases, thereby possibly causing retort blushing (white spots). Such a large amount of isophthalic acid is hence not preferred either.

It is to be note that, if the copolymer resin with polyethylene terephthalate contained as the principal component is used as the polyester I, the amount of isophthalic acid in the copolymer resin may more preferably be 2 to 9 mol %.

If the copolymer resin with polyethylene terephthalate contained as the principal component is used as the polyester I, on the other hand, ethylene glycol alone is suited as a glycol component contained in the copolymer resin. However, one or more of other glycol components, for example, propylene glycol, 1,4-butanediol, diethylene glycol, 1,6-hexylene glycol, cyclohexane dimethanol, bisphenol A ethylene oxide addition product, and the like may also be contained to an extent not impairing the essence of the present invention.

A description will next be made regarding the melting point of the polyester II and a reason for the range of its melting point.

In the present embodiment, the melting point of the polyester II may preferably be 215° C. to 225° C. In other words, the polyester II may preferably be a polybutylene terephthalate resin alone (homopolymer) in the present embodiment from the viewpoint of suppressing the occurrence of retort blushing (white spots).

Nonetheless, the polyester II may also be a copolymer resin within a range not impairing the object of the present invention. If this is the case, one or more of known dicarboxylic acid components other than terephthalic acid and/or known glycol components other than 1,4-butanediol may also be contained as a copolymerization component or copolymerization components.

Described specifically, the melting point of the polybutylene terephthalate resin alone (homopolymer) is 225° C. In the present embodiment, however, some melting point depressions are permissible through transesterification with polyethylene terephthalate upon such copolymerization or resin layer formation as described above.

Even in the above case, however, a melting point lower than 215° C. is not preferred because such a low melting point may lead to insufficient suppressive effect on the occurrence of retort blushing (white spots).

### <X-Ray Diffraction Peak Intensity Ratio>

Next, in the resin-coated metal sheet of the present embodiment for the container, the resin layer A is characterized by having, in X-ray diffraction thereof, a peak intensity ratio satisfying the following formulas (1) and (2).

(I₁₀₀)_{II}/(I₁₀₀)_{I}≥1.5 (1)

(I₁₀₀)_{II}/(I₀₁₁)_{II}<1.5 (2)

Here, the (I₁₀₀)_{II} is a maximum peak intensity observed in a range of 2θ=22.5° to 24.0° in X-ray diffraction of the polyester II. It is to be noted that a peak observed in the range of 2θ=22.5° to 24.0° in X-ray diffraction of the polybutylene terephthalate resin is a diffraction peak assigned to the (100) plane of PBT.

Similarly, the (I₁₀₀)_{I} is a maximum peak intensity observed in a range of 2θ=25.4° to 26.7° in X-ray diffraction of the polyester I. It is to be noted that a peak observed in the range of 2θ=25.4° to 26.7° in X-ray diffraction of a polyethylene terephthalate resin is a diffraction peak assigned to the (100) plane of PET.

The (I₀₁₁)_{II} is a maximum peak intensity observed in a range of 2θ=16.0° to 18.0° in X-ray diffraction of the polyester II. It is to be noted that a peak observed in the range of 2θ=16.0° to 18.0° in X-ray diffraction of the polybutylene terephthalate resin is a diffraction peak assigned to the (011) plane of PBT.

Accordingly, the above-described formulas (1) and (2) are considered to represent the following indexes. Described specifically, “(I₁₀₀)_{II}/(I₁₀₀)_{I}” in the above-described formula (1) expresses the degree of crystallization of the PBT resin in comparison with that of the PET resin in the resin layer A by focusing on the (100) planes of their crystals. From satisfaction of “(I₁₀₀)_{II}/(I₁₀₀)_{I}≥1.5” as in the formula (1), it is possible to confirm that PBT has crystallized sufficiently in the resin layer A to such an extent as to achieve the object of the present application.

On the other hand, “(I₁₀₀)_{II}/(I₀₁₁)_{II}” in the above-described formula (2) expresses the degrees of crystallization in the (100) plane and (011) plane by focusing on the PBT resin alone in the resin layer A. Here, in the present embodiment, the resin layer A is characterized to satisfy “(I₁₀₀)_{II}/(I₀₁₁)_{II}<1.5” as in the formula (2). From satisfaction of the formula (2), it is possible to confirm that the resin layer A has not been stretched (is unstretched and unoriented).

In short, the resin layer A may preferably contain crystals of the PBT resin without stretch-orientation for a reason to be described hereinafter.

Described specifically, using the resin-coated metal sheet of the present embodiment, a container such as a metal can is manufactured by way of can-making work such as drawing and ironing. If stretch-orientation had been induced in a resin layer, the resin layer would not have workability sufficient to follow these can-making work and the like, leading to a possibility that the resin layer would separate and rupture through can-making work such as drawing and ironing. Stretch-orientation is therefore not preferred.

In the present embodiment, the resin layer A is therefore preferably not a stretched film but is in an unstretched and unoriented state to ensure can-making work such as drawing and ironing.

It is to be noted that in the present embodiment, the measurement of the peak intensities in X-ray diffraction of the resin layer A can be conducted by an X-ray diffraction measurement method that is commonly employed for resins.

For example, a metal sheet with a resin layer formed thereon is measured at a resin-coated side thereof by using an X-ray diffractometer. As examples of measurement conditions, Cu (wavelength λ: 0.1542 nm) is used as a target in an X-ray tube, and a receiving slit is selected such that diffraction peaks can be separated at approx. 40 kV tube voltage and approx. 20 mA tube current.

A sample is mounted such that the incident angle and reflection angle of an X-ray are each θ at a diffraction angle 2θ and the incident X-ray and the diffracted X-ray are symmetric with respect to the normal line to a film plane. While allowing the incident angle θ and the reflection angle θ to always remain equal to each other, an X-ray diffraction spectrum is measured by performing scanning over a diffraction angle 20 range, for example, of 10° to 30°.

The point of intensity at 2θ=10° and the point of intensity at 2θ=30° are connected by a straight line segment to determine a background, and the heights of appeared peaks are measured from the background.

### <Resin Layer B>

A description will next be made of a case in which, in the present embodiment, the resin layer formed on the metal sheet includes a plurality of layers.

When the resin layer includes a plurality of layers, the resin layer may preferably be formed such that the above-mentioned resin layer A becomes an outermost layer (a layer that is the farthest from the metal sheet 1 and is to be brought into contact with laminating rolls).

Described specifically, in the resin-coated metal sheet of the present embodiment for the container, the resin layer B including two or more layers is formed on at least one side of the metal sheet as illustrated in FIG. 2. In this case, the resin layer B may preferably have the above-mentioned resin layer A as its outermost layer.

It is to be noted that as illustrated in FIG. 2, the resin-coated metal sheet of the present embodiment may preferably include, between the resin layer A and the metal sheet, at least a main layer C such as that to be described hereinafter.

Described specifically, it is preferred that the main layer C contains a polyester resin as a principal component and is formed from a blend of 20 to 50 wt % of the polyester I having the melting point of 210° C. to 256° C. and 50 to 80 wt % of the polyester II having the melting point of 215° C. to 225° C.

Descriptions of the polyester I and polyester II are omitted, because the same polyesters as in the resin layer A can be applied.

Concerning the main layer C, 20 to 50 wt % of the polyester I and 50 to 80 wt % of the polyester II are blended for a reason to be descried hereinafter. Described specifically, the main layer C does not come into direct contact with the laminating rolls, so that even if the amount of the polyester II exceeds 70 wt %, there is a low possibility of causing a reduction in lamination properties such as sticking of the resin to the laminating rolls when forming the resin layer on the metal sheet 1. The main layer C therefore allows to increase the amount of the polyester II compared with the resin layer A. If the amount of the polyester II exceeds 80 wt % in the main layer C, however, the melting point of the whole resin layer B decreases excessively. Such an excessively decreased melting point leads to a higher possibility of sticking of the resin to the laminating rolls or induction of reduced lamination properties such as occurrence of wrinkling of a film when forming the resin layer on the metal sheet 1, and therefore is not preferred.

It is to be noted that the above description regarding the case of the resin layer A similarly applies to a case in which the amount of the polyester II is lower than 50 wt % in the main layer C.

It is also to be noted that the amount of PBT in the main layer C may be the same as or different from the amount of PBT in the resin layer A.

If the resin layer A and the main layer C have different amounts of PBT, however, differences arise in viscosity and thermal properties between the melted resins, so that there is a possibility of occurrence of a defective shape upon the manufacture of the resin film. It is therefore preferred, from the viewpoint of mitigating such a problem, to make the amount of PBT equal in the resin layer A and the main layer C.

Concerning FIG. 2, the description has been made taking, as an example, the case in which the resin layer is formed in the two-layer configuration. In the present embodiment, however, the resin layer is not limited to the cases of a single layer and two layers and may have a configuration of three or more layers. If this is the case, it is preferred, from the viewpoint of suppression of retort blushing (white spots), to form the resin layer A as the outermost layer as in the case of the two-layer configuration.

If the resin layer is formed in a configuration of three or more layers, an adhesive layer D, such as that to be described hereinafter, can be arranged between the metal sheet and the main layer C and on a surface that will come into contact with the metal sheet. Preferably, the adhesive layer D contains a polyester resin as a principal component and is formed from a blend of 30 to 50 wt % of the polyester I having the melting point of 210° C. to 256° C. and 50 to 70 wt % of the polyester II having a melting point of 215° C. to 223° C. for a reason to be described hereinafter.

In the configuration illustrated in FIG. 2, the main layer C does not come into direct contact with the laminating rolls, and therefore the upper limit amount of the polyester II is 80 wt %. In the configuration of three layers or more, on the other hand, the adhesive layer D does not come into direct contact with the laminating rolls, but there is a possibility that the adhesion with the metal sheet 1 may decrease in a range in which the amount of the polyester II exceeds 70 wt %. If the adhesive layer D is arranged, the upper limit of the amount of the polyester II in the adhesive layer D may therefore preferably be set at 70 wt %. On the other hand, the lower limit of the amount of the polyester II is set at 50 wt % for a similar reason as in the case of the resin layer A mentioned above.

In the case that the resin layer includes a plurality of layers, on the other hand, it is preferred that as the overall composition of the resin layer (the resin layer B in the case of FIG. 2) formed of the individual layers in combination, the resin layer, similarly to the resin layer A, contains a polyester resin as a principal component and is formed from a blend of 30 to 50 wt % of the polyester I having the melting point of 210° C. to 256° C. and 50 to 70 wt % of the polyester II having the melting point of 215° C. to 223° C.

In the case that the resin layer includes the plurality of layers, the peak intensity ratio in X-ray diffraction of the whole resin layer (the resin layer B in the case of FIG. 2) formed of the individual layers in combination satisfies the above-described formula (1) and formula (2).

In the present embodiment, merits in the case that the resin layer is formed of the plurality of layers include examples such as the following.

If a film has low slip properties, for example, problems such as occurrence of a defective shape like wrinkling or rupture of the film arise when taking up the film or when paying out the film. It is therefore common to add a lubricant in the resin. If the resin layer includes a plurality of layers, the addition of the lubricant to one of the layers is sufficient, so that the amount of the lubricant to be added can be reduced, thereby bringing about a merit in cost.

In general, the lubricant is added to both or one of the resin layer A as the outermost layer and the layer on a side that will come into contact with the metal sheet (the main layer C in the case of the two layers illustrated in FIG. 2, or the adhesive layer D in the case of three layers or more). From the viewpoint of the above-described merit in cost by the reduction in the amount of the lubricant to be added, the lubricant may preferably be added to either the resin layer A or the adhesive layer D.

Also, in the case that a pigment is added to a resin, the pigment can be added to one of a plurality of layers if a resin layer includes the plurality of layers. The amount of the pigment to be added can therefore be reduced, thereby bringing about a merit in cost. In general, the pigment is added to the main layer C.

### <Thicknesses and Thickness Ratio of Resin Layers>

A description will next be made regarding the thickness of the resin layer to be formed on the metal sheet, and the thicknesses and thickness ratio of the resin layers to be formed on the metal sheet.

The total thickness of the resin layer or layers to be formed on the metal sheet may preferably be 3 to 25 μm from the viewpoint of the adhesion or the like between the resin film and the metal sheet when manufacturing a container. Described specifically, if the resin layer is a single layer in the present embodiment as illustrated in FIG. 1, the thickness of the resin layer A may preferably be 3 to 25 μm.

If the resin layer B includes a plurality of layers as illustrated in FIG. 2, on the other hand, the total thickness of the resin layer B (the total of the thicknesses of the resin layer A and the main layer C in FIG. 2) may preferably be 3 to 25 μm, notably 8 to 15 μm.

If the total thickness of the resin layer B is less than 3 μm, a large-scale manufacturing apparatus is needed, leading to a higher possibility of an eventual increase in cost. Such a small total thickness of the resin layer B is therefore not preferred. If the total thickness of the resin layer B is greater than 25 μm, on the other hand, the amount of PBT contained in the resin layer B becomes excessively high. Crystallization hence proceeds excessively, leading to a deterioration in workability. Such a great total thickness of the resin layer B is therefore not preferred.

Further, if the resin layer B includes a plurality of layers as illustrated in FIG. 2, no particular limitation is imposed on the thickness ratio of the individual layers. If a lubricant is added to the resin layer A as the outermost layer or to the adhesive layer D as mentioned above, however, the layer with the lubricant added therein may preferably be formed thin within a range not impairing the workability. As a thickness ratio, the layer with the lubricant added therein may preferably be set at 1/5 to 2/3 relative to, for example, the main layer C.

### [Manufacturing Method of Resin-Coated Metal Sheet]

A description will next be made regarding a manufacturing method of the resin-coated metal sheet in the present embodiment, but the present invention should not be limited to or by the following description.

The resin-coated metal sheet of the present embodiment is manufactured by forming the resin layer A on at least one side of the metal sheet 1.

In the present embodiment, a known method can be used as a method of forming the resin layer A on the metal sheet 1. Examples may include a method that extrudes the resin in a film form directly onto the metal sheet 1 through a T-die of an extruder (extrusion coating method) and a method that laminates a resin film, which has been manufactured beforehand, on the metal sheet 1 with or without an adhesive interposed therebetween.

When forming the resin layer A on the metal sheet 1 by the above-described extrusion coating method, the temperatures of the metal sheet 1 and a pair of laminating rolls can be set as will be described hereinafter. Described specifically, in the present embodiment, the metal sheet 1 which has been continuously delivered from metal sheet feed means is heated by heating means to a temperature sufficiently high to enable adhesion of a resin film to the metal sheet 1, and the resin which has been extruded in the film form through the T-die of the extruder is brought into contact with at least one side of the heated metal sheet 1 via a pre-roll. Between the pair of laminating rolls, the resulting resin film and the metal sheet 1 are joined one over the other, nipped, bonded under pressure, and laminated to form the resin layer A, immediately followed by quenching.

Here, the temperature of the metal sheet 1 may preferably be 200° C. to 280° C. As the temperature of the laminating rolls, 100° C. or lower may be preferred, with 70° C. or lower being more preferred.

If the resin layer A is formed by laminating the resin film on the metal sheet 1, on the other hand, the resin film delivered from the film feed means is first brought into contact with the heated metal sheet 1, for example. Between a pair of laminating rolls, the resin film and the metal sheet 1, which are in contact with each other, are then joined one over the other, nipped, bonded under pressure, and laminated to form the resin layer A, immediately followed by quenching. Here, the temperatures of the metal sheet 1 and laminating rolls are similar to those in the case of the extrusion coating method.

When the resin film is laminated on the metal sheet, however, crystallization once proceeds in the course of being heated. Depending on the resin composition and forming conditions, the crystalline state even after the lamination may also be affected. If this is the case, difficulties are encountered in controlling the resin film in a desired crystalline state. In addition, the film is once formed and taken up, thus posing many problems in the production aspect, for example, film wrinkling tends to occur and bubbles remain between the resin layer and the metal sheet to impede the adhesion. These difficulties and problems lead to an increase in cost.

As an adhesive to be used when laminating the resin film via the adhesive, a general adhesive can be used. Examples can include polyester based emulsion type adhesives, polyester urethane resin based emulsion type adhesives, epoxy-phenol resin based thermosetting type adhesives, and the like.

When forming the resin layer A on the metal sheet 1 by the extrusion coating method in the present embodiment, the formation method is characterized by including the following steps.

First, 30 to 50 wt % of the above-mentioned polyester I and 50 to 70 wt % of the above-mentioned polyester II are blended, and are extruded in a melted state through a die head of an extruder directly onto the metal sheet (first step).

It is to be noted that the melting points and the like of the polyester I and polyester II are as mentioned above and therefore their description is omitted here.

Here, as a method of blending the polyester I and the polyester II, a known method can be used. For example, resin chips of the polyester I and those of the polyester II may be mixed together, and may then be charged into an extruder to melt and blend them.

As an alternative method, resin chips of the polyester I and those of the polyester II may be separately charged into and melted in different extruders, and the polyester I and the polyester II may then be blended together before extrusion through a die.

The kneading temperature and kneading time of the resins in the extruder or the extruders can be selectively set as desired. An excessively high kneading temperature is, however, not preferred because transesterification proceeds between the polyester I and the polyester II or these resins undergo pyrolysis.

In the present embodiment, the blend resin of polyester I and the polyester II may preferably be kneaded at 255° C. to 295° C. for 5 to 30 minutes.

Then, the blended polyester resin directly extruded onto the metal sheet 1 is bonded under pressure by laminating rolls to form the resin layer A on the metal sheet 1 (second step).

In the present embodiment, the peak intensity ratio in X-ray diffraction of the resin layer A formed on the metal sheet 1 is characterized by satisfying the formula (1) and formula (2) mentioned above in the section of the description of the resin-coated metal sheet.

When forming the resin layer B, which includes a plurality of layers (the two layers of the resin layer A and the main layer C in FIG. 2) on the metal sheet 1 as illustrated in FIG. 2, production can be made as will be described hereinafter.

Described specifically, in the first step described above, the resin which makes up the resin layer A and the resin which makes up the main layer C can be concurrently extruded in melted states from the die heads of respective extruders directly onto the metal sheet such that two layers are formed. In this case, a known multi-manifold die or the like can be used.

As an alternative, in the first step described above, the main layer C may first be extruded directly onto the metal sheet 1, followed by direct extrusion of the resin layer A.

Subsequently, the two-layered resin layer B including the resin layer A and the resin layer C can be formed by bonding the resin layer A and the main layer C, which have been extruded directly onto the metal sheet 1, together under pressure by the laminating rolls in the second step mentioned above.

Here, the resin which makes up the main layer C is characterized to be a polyester resin obtained by blending 20 to 50 wt % of the polyester I and 50 to 80 wt % of the polyester II.

In addition, the peak intensity ratio in X-ray diffraction of the resin layer B may preferably be characterized by satisfying the formula (1) and formula (2) mentioned above.

### [Container]

A description will next be made regarding the container such as the metal can in the present embodiment.

Examples of the container in the present embodiment can include, but are not limited to, metal cans such as beverage cans and food cans, square cans, 18 L square cans, drum cans, metal cases, and the like.

In the present embodiment, the metal can is configured from a can body (including a can body for a 3-piece can) and one or two can lids. The above-described resin-coated metal sheet in the present embodiment can be applied to both of these members.

In the present embodiment, the can body is made from the above-described resin-coated metal sheet by a known can-making method. Examples of the known can making method include drawing, drawing and ironing, stretch-drawing, stretch-ironing, and the like.

A can lid can be an easy-open can lid of what is called a stay-on tab type or an easy-open can lid of what is called a full-open type. As can lids, on the other hand, they can be top and bottom lids for a 3-piece can. These can lids can also be made by a known method.

In the present embodiment, the formation of the resin layer A or the resin layer B on the outer surface of the metal can is preferred from the viewpoint of suppressing the occurrence of retort blushing (white spots). On an inner surface of the metal can, another resin film may be additionally laminated, or a coating film may be formed. The resin film on the inner surface of the metal can may be the same as a resin film on the outer surface of the can.

In the metal can of the present embodiment, a still further layer such as a protective layer may also be formed on an outer side of the resin layer A or the resin layer B.

### EXAMPLES

The present invention will hereinafter be described more specifically by examples, but the present invention should not be limited to or by the following examples.

### [Production of Resin-Coated Metal Sheet]

As a metal sheet, a tin free steel (TFS) sheet of 0.16 mm thickness was used.

### Example 1

A polyethylene terephthalate copolymer resin containing 9 mol % of isophthalic acid was provided as the polyester I, and the polybutylene terephthalate resin (homopolymer) was provided as the polyester II. First, chips of the polyester I and chips of the polyester II, both being of the kinds presented in Table 1, were mixed together in the proportions presented in Table 1, and the resulting mixed chips were charged into an extruder and were then melted and kneaded there. As kneading conditions, the kneading temperature was set at 255° C., the ratio Q/N of the delivery rate Q (kg/h) to the extruder screw rpm N (rpm) was set at 1.0, and the residence time in the extruder was set to 20 minutes.

A resin for the resin layer A was prepared as described above. The resin for the resin layer A was extruded in a melted state onto the metal sheet which was heated at 250° C. via a pre-roll. The resulting resin layer and the metal sheet were nipped and laminated together between a pair of laminating rolls, whereby a resin-coated metal sheet was produced. In the production step described above, the temperature of the laminating rolls was set at 70° C. Further, the thickness of the resin layer A was set at 10 μm.

The metal sheet was coated on the opposite side thereof with a two-layer resin formed of a polyethylene terephthalate based resin containing 15 mol % of isophthalic acid as a copolymerization component and a polyethylene terephthalate based resin containing 2 mol % of isophthalic acid as a copolymerization component.

The resin layer A of the resulting resin-coated metal sheet was measured for thickness by an electromagnetic coating thickness meter. In addition, the X-ray diffraction peak intensity ratio of the resin layer A of the resulting resin-coated metal sheet was calculated. Measurement conditions for the X-ray diffraction peaks were set as will be described hereinafter.

### (Calculation of Oriented Crystallization Peak Intensity Ratio by X-Ray Diffraction)

X-ray diffraction peak intensities of the resulting resin-coated metal sheet were measured under the following conditions.

X-ray diffractometer: “RINT2000” manufactured by Rigaku Corporation

X-ray: CuKα X-ray (1.542 Angstrom)

Tube voltage: 40 kV

Tube current: 20 mA

X-ray beam diameter: 100 μm across

Detector: Curved position-sensitive detector (position sensitive proportional counter (PSPC))

Divergence slit: 1°

Vertical divergence limit slit: 10 mm

Scatter slit: 1.26 mm

Receiving slit: 0.30 mm

Monochrome receiving slit: 0.6 mm

Smoothing was performed by a weighted mean method.

As a background, a line extending between the point of intensity at 2θ=10° and the point of intensity at 2θ=30° was adopted.

From the resulting chart, the maximum peak intensity observed in a range of 2θ=22.5° to 24.0° was represented by (I₁₀₀)_{II}, the maximum peak intensity observed in a range of 2θ=25.4° to 26.7° was represented by (I₁₀₀)_{I}, the maximum peak intensity observed in a range of 2θ=16.0° to 18.0° was represented by (I₀₁₁)_{II}, and the values of (I₁₀₀)_{II}/(I₁₀₀)_{I} and (I₁₀₀)_{II}/(I₀₁₁)_{II} were determined, respectively.

### (Evaluation of Film Forming Properties)

The resulting resin-coated metal sheet was visually observed, and its film forming properties were evaluated as follows.

∘: There was neither wrinkling nor shrinkage on a film surface when observed visually.

Δ: There was/were some wrinkling and/or shrinkage on a film surface when observed visually.

x: There was/were wrinkling and/or shrinkage on a film surface when observed visually.

### (Evaluation of Lamination Properties)

Lamination properties of the resulting resin-coated metal sheet were evaluated as will be described hereinafter. Described specifically, when continuously laminating the resin layer on the metal sheet, the causes of occurrence of film tearing were visually determined upon continuous lamination of the film over 10000 m on the metal sheet, and the lamination properties were evaluated in accordance with the following standards.

∘: Neither wrinkling nor melt sticking of a film occurred.

Δ: Wrinkling and/or melt sticking of a film occurred several to 10 times.

x: Wrinkling and/or melt sticking of a film occurred 11 times or more.

### (Production of Metal Can)

The resin-coated metal sheet obtained as described above was coated with a wax-based lubricant, followed by being punched into a disk (blank) of 119.5 mm diameter such that the resin layer A would become the outer surface of a can to be produced. Drawing was applied to the punched disk (blank) by a punch and die to form a bottomed cylindrical body. On the bottomed cylindrical body, the forming of a can body and a can bottom was next performed according to a usual method. An opening end portion was trimmed, followed by neck-forming and flange-forming. A can lid with a polyethylene terephthalate film laminated on an inner surface thereof was secured on the opening end portion by double seaming, whereby a drawn can was completed.

### (Evaluation of Retort Blushing)

The drawn can thus obtained was filled with water, and a usual can lid was then seamed, whereby a filled can was obtained. Next, the filled can was placed in a retort oven and was subjected to autoclave sterilization treatment with steam at 125° C. for 30 minutes. After the autoclave sterilization treatment, the filled can was taken out of the retort oven and dipped in water to allow it to cool down to a room temperature. Evaluation was then visually made as to the occurrence/non-occurrence of retort blushing on a bottom portion of the can body.

∘: No retort blushing (white spots) occurred, and the can was usable in practice.

Δ: Slight retort blushing (white spots) occurred locally, but the can was still usable in practice.

x: Retort blushing (white spots) occurred, and the can was not usable in practice.

xx: The entire surface of the resin layer clouded, and the can was not usable in practice.

The results obtained from the above evaluations are presented in Table 1.

### Examples 2 to 3, Comparative Examples 1 to 4

In each of these examples and comparative examples, the procedures of Example 1 were followed except that the blend amounts of the polyester I and polyester II for the resin layer A were set as presented in Table 1. The results obtained are presented in Table 1

### Example 4

A resin for the main layer C was prepared by adding 1 wt % of Pigment Yellow 110 as a pigment to the same resin as the resin for the resin layer A. The resin for the resin layer A and the resin for the main layer C were extruded in melted states, respectively, through a multi-manifold die via a pre-roll such that the main layer C came into contact with the metal sheet, and the resulting resin layer and the metal sheet were nipped between laminating rolls, whereby a resin-coated metal sheet was produced. The thickness of the resin layer A, the thickness of the main layer C, and the total thickness of the resin layers were set at 2 μm, 6 μm, and 8 μm, respectively. Except for the foregoing, the procedures of Example 1 were followed. The results obtained are presented in Table 1.

### Examples 5 to 7

In each of these examples, the procedures of Example 4 were followed except that the total thickness of the resin layers was set as in Table 1. The results obtained are presented in Table 1.

### Example 8

A resin for the resin layer A was prepared by using the polyethylene terephthalate copolymer resin containing 2 mol % of isophthalic acid as the polyester I and blending the polyethylene terephthalate copolymer resin with the polybutylene terephthalate resin (homopolymer) as the polyester II in the proportions presented in Table 1. A resin for the main layer C was prepared by blending 39.5 wt % of the polyethylene terephthalate copolymer resin containing 2 mol % of isophthalic acid as the polyester I and 60 wt % of the polybutylene terephthalate resin (homopolymer) as the polyester II and further blending 0.5 wt % of a lubricant.

Next, a two-layer resin film having the resin layer A and the main layer C was formed as will be descried hereinafter. Described specifically, the resin for the resin layer A and the resin for the main layer C, after having been laminated in melted states in a lower part of a multi-manifold die, were delivered from a delivery port onto a chill roll. The resulting laminate was chilled and solidified into the two-layer resin film and was then continuously taken up on a coiler. The thickness of the resin layer A, the thickness of the main layer C, and the total thickness of the two-layer resin layer were set at 2 μm, 10 μm, and 12 μm, respectively.

Next, while paying out the taken-up two-layer resin film, the two-layer resin film was brought into contact with one side of the metal sheet heated at 250° C. Between a pair of laminating rolls, the two-layer resin film and the metal sheet were joined one over the other, nipped, bonded under pressure, and laminated. The temperature of the laminating rolls was set at 70° C. Except for the foregoing, the procedures of Example 4 were followed. The results obtained are presented in Table 1.

### Comparative Examples 5 to 8

In each of these comparative examples, as a resin for the resin layer A, 100 wt % of the polyethylene terephthalate copolymer resin containing 2 mol % of isophthalic acid was used as the polyester I. A resin for the resin layer C was prepared by using, as the polyester I, the same resin as the resin layer A and blending it with the polybutylene terephthalate resin (homopolymer), as the polyester II, in the proportions presented in Table 1.

Next, a two-layer resin film having the resin layer A and the main layer C was prepared, in which the thickness of the resin layer A, the thickness of the main layer C, and the total thickness were set at 2 μm, 8 μm, and 10 μm, respectively. Subsequently, the two-layer resin film was laminated on the metal sheet. Except for the foregoing, the procedures of Example 8 were followed. The results obtained are presented in Table 1.

### Comparative Example 9

A resin for the resin layer A was prepared by using the polyethylene terephthalate copolymer resin containing 2 mol % of isophthalic acid as the polyester I and using the polybutylene terephthalate resin (homopolymer) as the polyester II. After preparing a single-layer resin film of 10 μm thickness formed from the resin layer A, the single-layer resin film was laminated on the heated metal sheet to prepare a resin-coated metal sheet. Except for the foregoing, the procedures of Example 8 were followed. The results obtained are presented in Table 1.

### Comparative Example 10

As a resin for the resin layer A, 100 wt % of the polybutylene terephthalate resin (homopolymer) was used as the polyester II. After preparing a single-layer resin film formed from the resin layer A, the single-layer resin film was laminated on the heated metal sheet to prepare a resin-coated metal sheet. The thickness of the resin layer was set at 15 μm. Except for the foregoing, the procedures of Example 9 were followed. The results obtained are presented in Table 1.

### Comparative Example 11

A resin for the resin layer A was prepared by blending the polyester I and the polyester II in the proportions presented in Table 1. A resin for the resin layer C was prepared by blending 20 wt % of the polyethylene terephthalate copolymer resin containing 2 mol % of isophthalic acid as the polyester I and 80 wt % of the polybutylene terephthalate resin (homopolymer) as the polyester II. A resin for the adhesive layer D was prepared by blending 39.5 wt % of the polyethylene terephthalate copolymer resin containing 2 mol % of isophthalic acid as the polyester I and 60 wt % of the polybutylene terephthalate resin (homopolymer) as the polyester II and further blending 0.5 wt % of the lubricant.

Next, a three-layer resin film having the resin layer A, the main layer C, and the adhesive layer D in this order was formed as will be descried hereinafter. Described specifically, the resins, after having been laminated in melted states in a lower part of a multi-manifold die, were delivered from a delivery port onto a chill roll. The resulting laminate was chilled and solidified into the three-layer resin film and was then continuously taken up on a coiler. The thickness of the resin layer A, the thickness of the main layer C, the thickness of the adhesive layer D, and the total thickness of the three-layer resin layer were set at 2 μm, 6 μm, 4 μm, and 12 μm, respectively.

Next, while paying out the taken-up three-layer resin film, the three-layer resin film was brought into contact with one side of the metal sheet heated at 250° C. Between a pair of laminating rolls, the three-layer resin film and the metal sheet were joined one over the other, nipped, bonded under pressure, and laminated. The temperature of the laminating rolls was set at 70° C. Except for the foregoing, the procedures of Example 8 were followed. The results obtained are presented in Table 1.

### Comparative Example 12

A resin for the resin layer A was prepared by using a polyethylene terephthalate copolymer resin containing 10 mol % of isophthalic acid as the polyester I and the polybutylene terephthalate resin (homopolymer) as the polyester II, and blending those resins in the proportions presented in Table 1. After preparing a single-layer resin film formed from the resin layer A, the single-layer resin film was laminated on the heated metal sheet to prepare a resin-coated metal sheet. The thickness of the resin layer was set at 15 μm. Except for the foregoing, the procedures of Comparative Example 9 were followed. The results obtained are presented in Table 1.

### Comparative Example 13

A resin for the resin layer A was prepared by using the polyethylene terephthalate copolymer resin containing 2 mol % of isophthalic acid as the polyester I and the polybutylene terephthalate resin (homopolymer) as the polyester II, and blending those resins in the proportions presented in Table 1. After preparing a single-layer resin film formed from the resin layer A, the single-layer resin film was laminated on the heated metal sheet to prepare a resin-coated metal sheet. The thickness of the resin layer was set at 15 μm. Except for the foregoing, the procedures of Comparative Example 9 were followed. The results obtained are presented in Table 1.

TABLE 1

| | | | | | | | | | | Main layer C |
|---|---|---|---|---|---|---|---|---|---|---|
| | | Resin layer A (outermost layer) | | | | | | | | (lower layer) |
| | | Polyester I | | | | Polyester II | | | | Polyester I |
| | | Blend | | Copolymerized | Melting | Blend | | Melting | | Blend |
| | | amount | | amount | point | amount | | point | Thickness | amount |
| Example | | (wt. %) | Resin | (mol %) | (° C.) | (wt. %) | Resin | (° C.) | (μm) | (wt. %) |
| Example 1 | 1 layer | 50 | PET based | IA-9 | 226 | 50 | PBT | 223 | 10 | — |
| Example 2 | 1 layer | 40 | PET based | IA-9 | 226 | 60 | PBT | 223 | 10 | — |
| Example 3 | 1 layer | 30 | PET based | IA-9 | 226 | 70 | PBT | 223 | 10 | — |
| Example 4 | 2 layers | 40 | PET based | IA-9 | 226 | 60 | PBT | 223 | 2 | 40 |
| Example 5 | 2 layers | 40 | PET based | IA-9 | 226 | 80 | PBT | 223 | 2 | 40 |
| Example 6 | 2 layers | 40 | PET based | IA-9 | 228 | 60 | PBT | 223 | 2 | 40 |
| Example 7 | 2 layers | 40 | PET based | IA-9 | 226 | 80 | PBT | 223 | 2 | 40 |
| Example 8 | 2 layers | 40 | PET based | IA-2 | 248 | 60 | PBT | 223 | 2 | 395 |
| Comparative | 1 layer | 70 | PET based | IA-9 | 226 | 30 | PBT | 223 | 10 | — |
| Example 1 | | | | | | | | | | |
| Comparative | 1 layer | 65 | PET based | IA-9 | 226 | 35 | PBT | 223 | 10 | — |
| Example 2 | | | | | | | | | | |
| Comparative | 1 layer | 60 | PET based | IA-9 | 226 | 40 | PBT | 223 | 10 | — |
| Example 3 | | | | | | | | | | |
| Comparative | 1 layer | 20 | PET based | IA-9 | 226 | 80 | PBT | 223 | 10 | — |
| Example 4 | | | | | | | | | | |
| Comparative | 2 layers | 100 | PET based | IA-2 | 248 | 0 | — | — | 2 | 70 |
| Example 5 | | | | | | | | | | |
| Comparative | 2 layers | 100 | PET based | IA-2 | 248 | 0 | — | — | 2 | 60 |
| Example 6 | | | | | | | | | | |
| Comparative | 2 layers | 100 | PET based | IA-2 | 248 | 0 | — | — | 2 | 50 |
| Example 7 | | | | | | | | | | |
| Comparative | 2 layers | 100 | PET based | IA-2 | 248 | 0 | — | — | 2 | 40 |
| Example 8 | | | | | | | | | | |
| Comparative | 1 layer | 70 | PET based | IA-2 | 248 | 30 | PBT | 223 | 10 | — |
| Example 9 | | | | | | | | | | |
| Comparative | 1 layer | 0 | — | — | — | 100 | PBT | 223 | 15 | — |
| Example 10 | | | | | | | | | | |
| Comparative | 3 layers | 50 | PET based | IA-2 | 248 | 50 | PBT | 223 | 2 | 20 |
| Example 11 | | | | | | | | | | |
| Comparative | 1 layer | 55 | PET based | IA-10 | 223 | 45 | PBT | 223 | 15 | — |
| Example 12 | | | | | | | | | | |
| Comparative | 1 layer | 55 | PET based | IA-2 | 248 | 48 | PBT | 223 | 15 | — |
| Example 13 | | | | | | | | | | |

| | | Main layer C (lower layer) | | | | | | | | Total |
|---|---|---|---|---|---|---|---|---|---|---|
| | | Polyester I | | | Polyester II | | | | | thickness |
| | | | Copolymerized | Melting | Blend | | Melting | | | of resin |
| | | | amount | point | amount | | point | Additions | Thickness | layer(s) |
| Example | | Resin | (mol %) | (° C.) | (wt. %) | Resin | (° C.) | I | (μm) | (μm) |
| Example 1 | 1 layer | — | — | — | — | — | — | — | — | 10 |
| Example 2 | 1 layer | — | — | — | — | — | — | — | — | 10 |
| Example 3 | 1 layer | — | — | — | — | — | — | — | — | 10 |
| Example 4 | 2 layers | PET based + | IA-9 | 226 | 60 | PBT | 223 | — | 6 | 8 |
| | | pigmnet | | | | | | | | |
| Example 5 | 2 layers | PET based + | IA-9 | 226 | 60 | PBT | 223 | — | 8 | 10 |
| | | pigmnet | | | | | | | | |
| Example 6 | 2 layers | PET based + | IA-9 | 226 | 60 | PBT | 223 | — | 10 | 12 |
| | | pigmnet | | | | | | | | |
| Example 7 | 2 layers | PET based + | IA-9 | 226 | 60 | PBT | 223 | — | 13 | 15 |
| | | pigmnet | | | | | | | | |
| Example 8 | 2 layers | PET based | IA-2 | 248 | 60 | PBT | 223 | Lubricant | 10 | 12 |
| | | | | | | | | 0.5 wt % | | |
| Comparative | 1 layer | — | — | — | — | — | — | — | — | 10 |
| Example 1 | | | | | | | | | | |
| Comparative | 1 layer | — | — | — | — | — | — | — | — | 10 |
| Example 2 | | | | | | | | | | |
| Comparative | 1 layer | — | — | — | — | — | — | — | — | 10 |
| Example 3 | | | | | | | | | | |
| Comparative | 1 layer | — | — | — | — | — | — | — | — | 10 |
| Example 4 | | | | | | | | | | |
| Comparative | 2 layers | PET based | IA-2 | 248 | 30 | PBT | 223 | — | 8 | 10 |
| Example 5 | | | | | | | | | | |
| Comparative | 2 layers | PET based | IA-2 | 248 | 40 | PBT | 223 | — | 8 | 10 |
| Example 6 | | | | | | | | | | |
| Comparative | 2 layers | PET based | IA-2 | 248 | 40 | PBT | 223 | — | 8 | 10 |
| Example 7 | | | | | | | | | | |
| Comparative | 2 layers | PET based | IA-2 | 248 | 60 | PBT | 223 | — | 8 | 10 |
| Example 8 | | | | | | | | | | |
| Comparative | 1 layer | — | — | — | — | — | — | — | — | 10 |
| Example 9 | | | | | | | | | | |
| Comparative | 1 layer | — | — | — | — | — | — | — | — | 15 |
| Example 10 | | | | | | | | | | |
| Comparative | 3 layers | PET based | IA-2 | 248 | 80 | PBT | 223 | — | 6 | 12 |
| Example 11 | | | | | | | | | | |
| Comparative | 1 layer | — | — | — | — | — | — | — | — | 10 |
| Example 12 | | | | | | | | | | |
| Comparative | 1 layer | — | — | — | — | — | — | — | — | 15 |
| Example 13 | | | | | | | | | | |

| | | Resin | | | Evaluation | Evaluation | | |
|---|---|---|---|---|---|---|---|---|
| | | layer | X-ray diffraction | | of film | of | Evaluation | |
| | | forming | peak intensity ratio | | forming | lamination | of retort | Comprehensive |
| Example | | method | [symbol] | [symbol] | properties | properties | blushing | evaluation |
| Example 1 | 1 layer | Extrusion | 1.93 | 0.81 | ◯ | ◯ | ◯ | ◯ |
| | | coating | | | | | | |
| Example 2 | 1 layer | Extrusion | 1.91 | 0.85 | ◯ | ◯ | ◯ | ◯ |
| | | coating | | | | | | |
| Example 3 | 1 layer | Extrusion | 1.88 | 0.89 | ◯ | ◯ | ◯ | ◯ |
| | | coating | | | | | | |
| Example 4 | 2 layers | Extrusion | 1.77 | 0.91 | ◯ | ◯ | ◯ | ◯ |
| | | coating | | | | | | |
| Example 5 | 2 layers | Extrusion | 2.16 | 1.11 | ◯ | ◯ | ◯ | ◯ |
| | | coating | | | | | | |
| Example 6 | 2 layers | Extrusion | 2.78 | 1.33 | ◯ | ◯ | ◯ | ◯ |
| | | coating | | | | | | |
| Example 7 | 2 layers | Extrusion | 1.98 | 0.95 | ◯ | ◯ | ◯ | ◯ |
| | | coating | | | | | | |
| Example 8 | 2 layers | Film | 1.74 | 0.86 | ◯ | ◯ | ◯ | ◯ |
| | | lamination | | | | | | |
| Comparative | 1 layer | Extrusion | 2.00 | 0.74 | ◯ | ◯ | XX | X |
| Example 1 | | coating | | | | | | |
| Comparative | 1 layer | Extrusion | 1.93 | 0.77 | ◯ | ◯ | XX | X |
| Example 2 | | coating | | | | | | |
| Comparative | 1 layer | Extrusion | 1.91 | 0.78 | ◯ | ◯ | X | X |
| Example 3 | | coating | | | | | | |
| Comparative | 1 layer | Film | 1.72 | 0.98 | X | X | ◯ | X |
| Example 4 | | lamination | | | (Defective | (Wrinkles) | | |
| | | | | | shape) | | | |
| Comparative | 2 layers | Film | 1.70 | 0.84 | ◯ | ◯ | XX | X |
| Example 5 | | lamination | | | | | | |
| Comparative | 2 layers | Film | 1.71 | 0.81 | ◯ | ◯ | XX | X |
| Example 6 | | lamination | | | | | | |
| Comparative | 2 layers | Film | 1.81 | 0.84 | Δ | Δ | X | X |
| Example 7 | | lamination | | | (Defective | (Wrinkles) | | |
| | | | | | shape) | | | |
| Comparative | 2 layers | Film | 1.78 | 0.86 | Δ | X | Δ | X |
| Example 8 | | lamination | | | (Defective | (Wrinkles) | | |
| | | | | | shape) | | | |
| Comparative | 1 layer | Film | 2.11 | 0.99 | ◯ | ◯ | XX | X |
| Example 9 | | lamination | | | | | | |
| Comparative | 1 layer | Film | 1.52 | 0.87 | ◯ | XX | ◯ | X |
| Example 10 | | lamination | | | | | | |
| Comparative | 3 layers | Film | 1.64 | 0.87 | Δ | Δ | ◯ | Δ |
| Example 11 | | lamination | | | (Wrinkles) | | | |
| Comparative | 1 layer | Film | 1.65 | 0.86 | ◯ | Δ | ◯ | Δ |
| Example 12 | | lamination | | | | | | |
| Comparative | 1 layer | Film | 2.01 | 1.03 | ◯ | Δ | ◯ | Δ |
| Example 13 | | lamination | | | | | | |

*PET based—PET-based copolymer resin
*IA-2—Isophthalic acid 2 mol %, IA-9—Isophthalic acid 9 mol %
*Comparative Example 11 includes an adhesive layer D (PET/IA-2 mol%: 39.5 wt %, PBT: 60 wt %, lubricant: 0.5 wt %; thickness, 4 μm) between the main layer C and a metal sheet. [symbol]
indicates data missing or illegible when filed

As presented in Table 1, the resin-coated metal sheets of the examples of the present embodiment demonstrated excellent results in all of film forming properties, lamination properties, and retort blushing resistance. On the other hand, the resin-coated metal sheets of the comparative examples gave unfavorable results in one or more of film forming properties, lamination properties, and retort blushing resistance.

### INDUSTRIAL APPLICABILITY

According to the present invention, the occurrence of retort blushing (white spots) and film delamination can be suppressed in containers such as beverage cans and food cans. Further, the resin-coated metal sheet according to the present invention is excellent in the adhesion between its metal sheet and resin layer and workability during can making, and has extremely high industrial applicability.

1. A resin-coated metal sheet for a container, comprising:
a metal sheet; and
a resin layer A coated on at least one side of the metal sheet,
wherein the resin layer A contains a polyester resin as a principal component,
the polyester resin is a blend of 30 to 50 wt % of a polyester I having a melting point of 210° C. to 256° C. and 50 to 70 wt % of a polyester II having a melting point of 215° C. to 225° C., and
the resin layer A has, in X-ray diffraction thereof, a peak intensity ratio satisfying following formulas (1) and (2),
(I₁₀₀)_{II}/(I₁₀₀)_{I}≥1.5 (1)
(I₁₀₀)_{II}/(I₀₁₁)_{II}<1.5 (2)
where the (I₁₀₀)_{II} is a maximum peak intensity observed in a range of 2θ=22.5° to 24.0° in X-ray diffraction of the polyester II,
the (I₁₀₀)_{I} is a maximum peak intensity observed in a range of 2θ=25.4° to 26.7° in X-ray diffraction of the polyester I, and
the (I₀₁₁)_{II} is a maximum peak intensity observed in a range of 2θ=16.0° to 18.0° in X-ray diffraction of the polyester II.

2. A resin-coated metal sheet for a container, comprising:
a metal sheet; and
a resin layer B coated on at least one side of the metal sheet,
wherein the resin layer B includes two or more layers and has a resin layer A as an outermost layer,
the resin layer B includes at least a main layer between the resin layer A and the metal sheet,
the resin layer A is formed from a blend of 30 to 50 wt % of a polyester I having a melting point of 210° C. to 256° C. and 50 to 70 wt % of a polyester II having a melting point of 215° C. to 225° C.,
the main layer is formed from a blend of 20 to 50 wt % of the polyester I having the melting point of 210° C. to 256° C. and 50 to 80 wt % of the polyester II having the melting point of 215° C. to 225° C., and
the resin layer B has, in X-ray diffraction thereof, a peak intensity ratio satisfying following formulas (1) and (2),
(I₁₀₀)_{II}/(I₁₀₀)_{I}≥1.5 (1)
(I₁₀₀)_{II}/(I₀₁₁)_{II}<1.5 (2)
where the (I₁₀₀)_{II} is a maximum peak intensity observed in a range of 2θ=22.5° to 24.0° in X-ray diffraction of the polyester II,
the (I₁₀₀)_{I} is a maximum peak intensity observed in a range of 2θ=25.4° to 26.7° in X-ray diffraction of the polyester I, and
the (I₀₁₁)_{II} is a maximum peak intensity observed in a range of 2θ=16.0° to 18.0° in X-ray diffraction of the polyester II.

3. The resin-coated metal sheet for a container according to claim 1, wherein the resin layer A has a thickness in a range of 3 to 25 μm.

4. The resin-coated metal sheet for a container according to claim 2, wherein the resin layer B has a thickness in a range of 3 to 25 μm.

5. A container made from the resin-coated metal sheet for a container according to claim 1.

6. A method of manufacturing a resin-coated metal sheet for a container, comprising:
a first step of extruding a polyester resin in a melted state from a die head of an extruder directly onto a metal sheet, the polyester resin being a blend of 30 to 50 wt % of a polyester I having a melting point of 210° C. to 256° C. and 50 to 70 wt % of a polyester II having a melting point of 215° C. to 225° C.; and
a second step of bonding the polyester resin which has been extruded directly onto the metal sheet under pressure between laminating rolls to form a resin layer A,
wherein the resin layer A has, in X-ray diffraction thereof, a peak intensity ratio satisfying following formulas (1) and (2),
(I₁₀₀)_{II}/(I₁₀₀)_{I}≥1.5 (1)
(I₁₀₀)_{II}/(I₀₁₁)_{II}<1.5 (2)
where the (I₁₀₀)_{II} is a maximum peak intensity observed in a range of 2θ=22.5° to 24.0° in X-ray diffraction of the polyester II,
the (I₁₀₀)_{I} is a maximum peak intensity observed in a range of 2θ=25.4° to 26.7° in X-ray diffraction of the polyester I, and
the (I₀₁₁)_{II} is a maximum peak intensity observed in a range of 2θ=16.0° to 18.0° in X-ray diffraction of the polyester II.

7. A method of manufacturing a resin-coated metal sheet for a container, comprising:
a first step of concurrently extruding a polyester resin which is a blend of 30 to 50 wt % of a polyester I having a melting point of 210° C. to 256° C. and 50 to 70 wt % of a polyester II having a melting point of 215° C. to 225° C. and a polyester resin for a main layer in melted states from a die head of an extruder directly onto a metal sheet such that a plurality of layers are formed; and
a second step of bonding the polyester resins which have been extruded directly onto the metal sheet under pressure between laminating rolls to form a resin layer B that includes two or more layers,
wherein the polyester resin for the main layer is a polyester resin obtained by blending 20 to 50 wt % of the polyester I having the melting point of 210° C. to 256° C. and 50 to 80 wt % of the polyester II having the melting point of 215° C. to 225° C., and
the resin layer B has, in X-ray diffraction thereof, a peak intensity ratio satisfying following formulas (1) and (2),
(I₁₀₀)_{II}/(I₁₀₀)_{I}≥1.5 (1)
(I₁₀₀)_{II}/(I₀₁₁)_{II}<1.5 (2)
where the (I₁₀₀)_{II} is a maximum peak intensity observed in a range of 2θ=22.5° to 24.0° in X-ray diffraction of the polyester II,
the (I₁₀₀)_{I} is a maximum peak intensity observed in a range of 2θ=25.4° to 26.7° in X-ray diffraction of the polyester I, and
the (I₀₁₁)_{II} is a maximum peak intensity observed in a range of 2θ=16.0° to 18.0° in X-ray diffraction of the polyester II.
